(19) United States
(12) Patent Application Publication
(10) Pub. No.: US 2014/0115705 A1
(43) Pub. Date: Apr. 24, 2014

(54) METHOD FOR DETECTING ILLEGAL CONNECTION AND NETWORK MONITORING APPARATUS

(71) Applicant: FUJITSU LIMITED, Kawasaki-shi (JP)

(72) Inventors: Yuki Fujishima, Yokohama (JP); Masanobu Morinaga, Yokohama (JP)

(73) Assignee: FUJITSU LIMITED, Kawasaki-shi (JP)

(21) Appl. No.: 13/951,652

(22) Filed: Jul. 26, 2013

(30) Foreign Application Priority Data
Oct. 22, 2012 (JP) 2012-233189

(51) Int. Cl. H04L 29/06

(52) U.S. Cl. CPC H04L 63/1408
USPC 726/23

(57) ABSTRACT

A network monitoring apparatus acquires a first packet transmitted from a first information processing apparatus to a second information processing apparatus. The network monitoring apparatus acquires a second packet transmitted from the second information processing apparatus to the first information processing apparatus. The second packet is transmitted within a predetermined time period since the transmission of the first packet. The network monitoring apparatus determines whether the first packet is a packet according to a protocol used for transmitting a file and the second packet is related to a connection established from the second information processing apparatus to the first information processing apparatus. The network monitoring apparatus outputs result information depending on a result of the determination.

### CROSS-REFERENCE TO RELATED APPLICATION

This application is based upon and claims the benefit of priority from the prior Japanese Patent Application No. 2012-233189 filed on Oct. 22, 2012, the entire contents of which are incorporated herein by reference.

### FIELD

The embodiments discussed herein are related to a method for detecting illegal connection and a network monitoring apparatus.

### BACKGROUND

Nowadays, it is popular to manage information using an information processing apparatus. Thus important information such as personal information or confidential information is often stored in the information processing apparatus. However, in such a situation, a targeted attack may occur to illegally steal important information from an information processing apparatus of a particular individual or organization. In the targeted attack, an illegal program called malware may be used.

For example, an illegal program is sent into a target organization using e-mail or the like thereby causing an information processing apparatus used in the organization to be infected with the illegal program. The infection with the illegal program may cause the information processing apparatus to transmit important information stored in the information processing apparatus to an information processing apparatus controlled by an attacker. Furthermore, using the information processing apparatus infected with the illegal program as a steppingstone, the illegal program may be sent into another information processing apparatus connected to the same network to collect important information therefrom.

In view of the above, an effort has been made to achieve an information security system capable of detecting an attack by such an illegal program. Examples of information security systems include an intrusion detection system (IDS), an intrusion prevention system (IPS), a firewall, and the like. An example of a detection method is packet filtering which detects, based on an Internet protocol (IP) address and a port number, improper accessing of a packet. Another example is pattern matching, which detects a packet that matches a feature (signature) of a known illegal program.

A method called a heuristic firewall has been proposed. In this method, high-reliability traffics and attacking traffics are learned beforehand, and the reliability of a packet stream is evaluated based on a result of the learning. A malicious code detection apparatus has also been proposed to monitor a transmission control protocol (TCP) traffic and detect a worm which is an illegal program capable of replicating itself. The malicious code detection apparatus detects an incoming TCP connection in a direction from an external network into an internal network, and also detects an outgoing TCP connection that is requested within a particular time period by a host in response to receiving a request of the incoming TCP connection. When the malicious code detection apparatus detects transmission of packets with the same content in an incoming TCP connection and an outgoing TCP connection, the malicious code detection apparatus determines that the packets include a worm.

International Publication Pamphlet No. WO01/80480 and Japanese Laid-open Patent Publication No. 2006-135963 disclose related techniques.

When a certain information processing apparatus (for example, an information processing apparatus infected first with an illegal program) collects important information from another information processing apparatus, a connection called a “reverse connection” may be established in a direction from the latter information processing apparatus (target apparatus) to the former information processing apparatus (collecting apparatus).

Let it be assumed, for example, that the collecting apparatus sends an illegal program into the target apparatus thereby causing the target apparatus to execute the illegal program. In this situation, if a process for providing service of accepting an access from the collecting apparatus is running as a resident process on the target apparatus for a long period, such a resident process may be conspicuous, which may result in an increase in probability that the attack is detected. To reduce the probability of being detected, the illegal program executed on the target apparatus may cause the target apparatus to establish a connection in a direction from the target apparatus to the collecting apparatus, instead of running the process for accepting accesses, such that important information is transmitted to the collecting apparatus using the connection. The access to the collecting apparatus from the target apparatus may be disguised as an access using a normal protocol such as a hypertext transfer protocol (HTTP).

Such a transmission of important information from the target apparatus to the collecting apparatus using the reverse connection may look like a normal communication, which creates a problem that the transmission of important information is not easily detected as an attack. Thus, when the illegal program is compressed or encrypted such that the illegal program is not easily detected, and the illegal program once succeeds in intruding in the target apparatus, it may not be easy to detect whether following communications are attacks or not.

### SUMMARY

According to an aspect of the present invention, provided is a method for detecting illegal connection executed by a network monitoring apparatus. The network monitoring apparatus acquires a first packet transmitted from a first information processing apparatus to a second information processing apparatus. The network monitoring apparatus acquires a second packet transmitted from the second information processing apparatus to the first information processing apparatus. The second packet is transmitted within a predetermined time period since the transmission of the first packet. The network monitoring apparatus determines whether the first packet is a packet according to a protocol used for transmitting a file and the second packet is related to a connection established from the second information processing apparatus to the first information processing apparatus. The network monitoring apparatus outputs result information depending on a result of the determination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing system according to an embodiment;

FIG. 2 is a diagram illustrating an example of an information processing system according to an embodiment;

FIG. 3 is a diagram illustrating an example of a hardware configuration of a network monitoring apparatus according to an embodiment;

FIG. 4 is a block diagram illustrating an example of a functional configuration of a network monitoring apparatus according to an embodiment;

FIG. 5 is a diagram illustrating an example of a targeted attack in a first phase;

FIG. 6 is a diagram illustrating an example of a targeted attack in a second phase;

FIGS. 7A to 7C are diagrams illustrating examples of structures of packets;

FIG. 8 is a diagram illustrating 3-way handshaking;

FIG. 9 is a diagram illustrating an example of a method of detecting a reverse connection according to an embodiment;

FIG. 10 is a diagram illustrating an example of a method of detecting a reverse connection according to an embodiment;

FIG. 11 is a diagram illustrating an example of a method of detecting a reverse connection according to an embodiment;

FIG. 12 is a diagram illustrating an example of an SMB request table;

FIG. 13 is a diagram illustrating an example of a reverse connection table;

FIG. 14 is a flowchart illustrating a flow of a monitoring process according to an embodiment;

FIG. 15 is a flowchart illustrating a flow of a monitoring process according to an embodiment; and

FIG. 16 is a flowchart illustrating a flow of a monitoring process according to an embodiment.

### DESCRIPTION OF EMBODIMENTS

Embodiments are described below with reference to drawings.

### First Embodiment

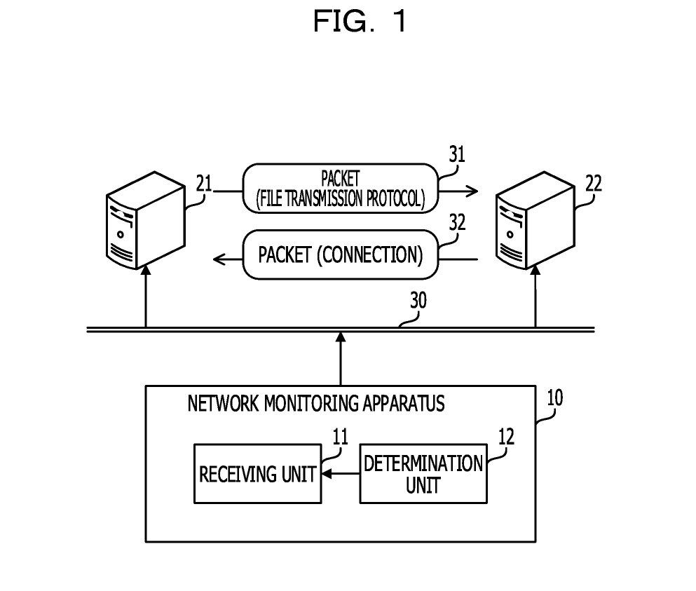

FIG. 1 illustrates an example of an information processing system according to a first embodiment.

In the first embodiment, the information processing system includes a network monitoring apparatus 10 and a plurality of information processing apparatuses including information processing apparatuses 21 and 22. The network monitoring apparatus 10 and the plurality of information processing apparatuses are connected to a network 30.

The plurality of information processing apparatuses including the information processing apparatuses 21 and 22 transmit a packet via the network 30. The transmission of packets may be performed, for example, using IP as a protocol in a network layer and TCP as a protocol in a transport layer. Each information processing apparatus may be a client apparatus serving as a terminal apparatus operated by a user or a server apparatus accessible by a client apparatus. For example, the information processing apparatus 21 may be a client apparatus and the information processing apparatus 22 may be a server apparatus.

There is a possibility that some of the plurality of information processing apparatuses is infected with an illegal program (which is also called malware) used to perform a targeted attack. For example, such an illegal program may be sent into some information processing apparatus connected to the network 30 from an attacker's information processing apparatus located in the outside of the network 30 through a wide area network such as the Internet.

A technique according to the first embodiment is described below taking as an example a case where the information processing apparatus 21 is first infected and the information processing apparatus 21 acquires important information from the information processing apparatus 22. It is assumed by way of example that an attack is performed using an illegal program as follows. First, the information processing apparatus 21 sends an illegal program into the information processing apparatus 22 thereby causing the information processing apparatus 22 to execute the illegal program. When sending the illegal program, for example, the information processing apparatus 21 may log in to the information processing apparatus 22 using login information stored in the information processing apparatus 21. The information processing apparatus 22 establishes a reverse connection to the information processing apparatus 21 and transmits important information stored in the information processing apparatus 22 to the information processing apparatus 21 via the reverse connection.

The network monitoring apparatus 10 monitors packets flowing over the network 30 to detect an illegal connection established by executing an illegal program. The network monitoring apparatus 10 may be a communication apparatus such as a router, a firewall, or the like, that transmits a packet, or may be a computer that acquires a copy of a packet from communication apparatuses and analyzes the acquired copy of the packet.

The network monitoring apparatus 10 includes a receiving unit 11 and a determination unit 12. The receiving unit 11 acquires a packet transmitted between a plurality of information processing apparatuses, and particularly, a packet transmitted between the information processing apparatuses 21 and 22. The receiving unit 11 is, for example, a wire communication interface connected to the network 30 via a cable. The determination unit 12 analyzes the acquired packet (which may also be described as a captured packet). The determination unit 12 may include a processor such as a central processing unit (CPU) a digital signal processor (DSP), or the like, and may further include a memory for storing a program to be executed by the processor. The processor may be a multiprocessor including a set of a plurality of processors. The determination unit 12 may include an integrated circuit such as an application specific integrated circuit (ASIC), a field-programmable gate array (FPGA), or the like.

The determination unit 12 determines whether acquired packets include such packets 31 and 32 satisfying the following condition. That is, the determination unit 12 detects, as the packet 31, a packet that is transmitted from the information processing apparatus 21 to the information processing apparatus 22 by using a particular protocol used in file transmission. The particular protocol may be, for example, an application layer protocol or a file sharing protocol such as a server message block (SMB) protocol. The determination as to whether each packet is a packet according to the particular protocol may be performed, for example, based on a destination port number described in a TCP header, or a header (for example, an SMB header) in an application layer.

The determination unit 12 also detects, as the packet 32, a packet that is acquired within a predetermined time period after the acquisition of the packet 31 and that is transmitted to establish a connection from the information processing apparatus 22 to the information processing apparatus 21. The packet 32 may be, for example, one in TCP 3-way handshaking packets (SYN, SYN-ACK, ACK) for establishing a connection from the information processing apparatus 22 to the information processing apparatus 21. In a case where the packet 32 is transmitted from the information processing apparatus 22 to the information processing apparatus 21, the sender of the packet 31 is the destination of the packet 32, and the destination of the packet 31 is the sender of the packet 32. The relationship between the packet 31 and the packet 32 may be determined, for example, based on a sender IP address and a destination IP address.

The determination unit 12 outputs information depending on a result of the determination. For example, when the determination unit 12 detects the packets 31 and 32 satisfying the above-described condition, the determination unit 12 determines that the connection established in direction from the information processing apparatus 22 to the information processing apparatus 21 is a reverse connection established by executing an illegal program. The information depending on the determination result may include information indicating the packet 31 transmitted from the information processing apparatus 21 to the information processing apparatus 22 in relation to the connection established in a direction from the information processing apparatus 22 to the information processing apparatus 21. The information depending on the determination result may be displayed on a display unit of the network monitoring apparatus 10 or may be transmitted to an administrator's information processing apparatus connected to the network 30. The display unit of the network monitoring apparatus 10 may be, for example, a display device, a warning lamp, or the like.

The determination unit 12 may detect, as the packet 31, a packet according to a particular protocol and including a file write command. The command type may be determined, for example, based on a header (for example, an SMB header) in the application layer. The packet 31 detected by the determination unit 12 may be a packet according to a particular protocol and including an executable code. The determination as to whether each packet includes an executable code may be performed, for example, based on a file header such as a portable executable (PE) header. The determination accuracy of the reverse connection may be increased by increasing the number of detection conditions of the packet 31.

In the first embodiment, the determination as to whether a connection from the information processing apparatus 22 to the information processing apparatus 21 is a reverse connection is performed based on whether a communication likely to include an illegal program is performed from the information processing apparatus 21 to the information processing apparatus 22 before the connection occurs. This makes it possible to detect a reverse connection and makes it possible to increase the probability of detecting an illegal connection established by executing an illegal program. Therefore, even in a case where the information processing apparatus 21 has successfully transmitted an illegal program into the information processing apparatus 22, it may be possible to detect a transmission of important information from the information processing apparatus 22 to the information processing apparatus 21, which allows an increase in security. When the network monitoring apparatus 10 detects a reverse connection, the network monitoring apparatus 10 may automatically limit the packet communication.

### Second Embodiment

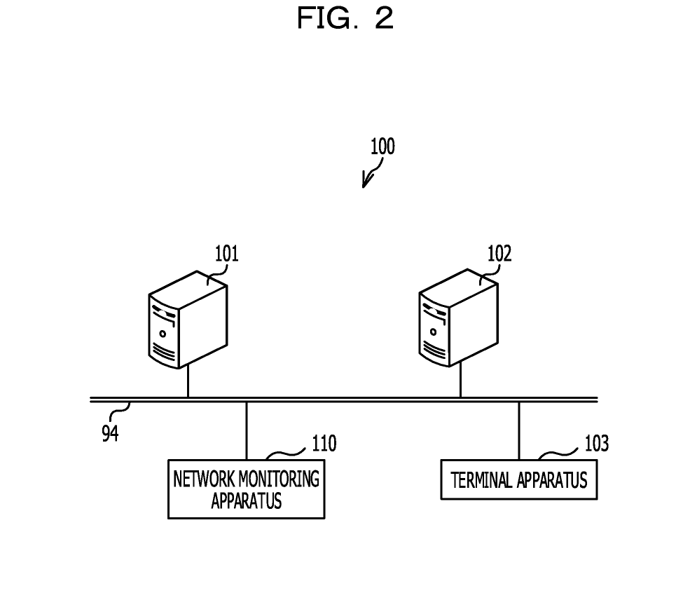

Next, a second embodiment is described below. FIG. 2 illustrates an example of an information processing system according to the second embodiment.

As illustrated in FIG. 2, in the second embodiment, the information processing system 100 includes information processing apparatuses 101 and 102, a terminal apparatus 103, and a network monitoring apparatus 110. The information processing apparatuses 101 and 102, the terminal apparatus 103, and the network monitoring apparatus 110 are connected to each other via a network 94 described below.

The information processing apparatuses 101 and 102 are each a server apparatus or a client apparatus operated by a user. The information processing apparatuses 101 and 102 transmit a packet via the network 94. The transmission of packets by the information processing apparatuses 101 and 102 is performed, for example, using IP as a protocol in the network layer and TCP as a protocol of the transport layer. The network monitoring apparatus 110 is a management apparatus used by an administrator of the information processing system 100.

The network monitoring apparatus 110 monitors packets transmitted via the network 94 to detect an attack caused by an illegal program that has intruded in the information processing apparatus 101. For example, the network monitoring apparatus 110 detects a process performed by executing the illegal program that has intruded in the information processing apparatus 101 to send another illegal program into the information processing apparatus 102 or detects a process of giving an execute command to a process performed by executing the sent illegal program. Hereinafter, for sake of simplicity, the process performed by executing the illegal program or the like may also be referred to as the illegal program or the like. The network monitoring apparatus 110 also detects, for example, a reverse connection established by executing an illegal program sent into the information processing apparatus 102 to transmit stolen information to the illegal program that has intruded in the information processing apparatus 101.

The terminal apparatus 103 is an apparatus that receives a warning issued by the network monitoring apparatus 110 when the network monitoring apparatus 110 detects an attack caused by an illegal program. When the terminal apparatus 103 receives the warning from the network monitoring apparatus 110, the terminal apparatus 103 displays a warning or generates a warning sound to notify a human operator or the like that the attack has been detected.

In the example illustrated in FIG. 2, the network monitoring apparatus 110 is disposed separately from the information processing apparatuses 101 and 102 and the terminal apparatus 103. Alternatively, the network monitoring apparatus 110 may operate as part of the information processing apparatus 102 or the terminal apparatus 103. In the following description, it is assumed by way of example that the network monitoring apparatus 110 is disposed separately from the information processing apparatuses 101 and 102 and the terminal apparatus 103. The network monitoring apparatus 110 may be a communication apparatus, such as a router, a firewall, or the like, that transmits a packet, or may be a computer that acquires a copy of a packet from communication apparatuses and analyzes the acquired copy of the packet.

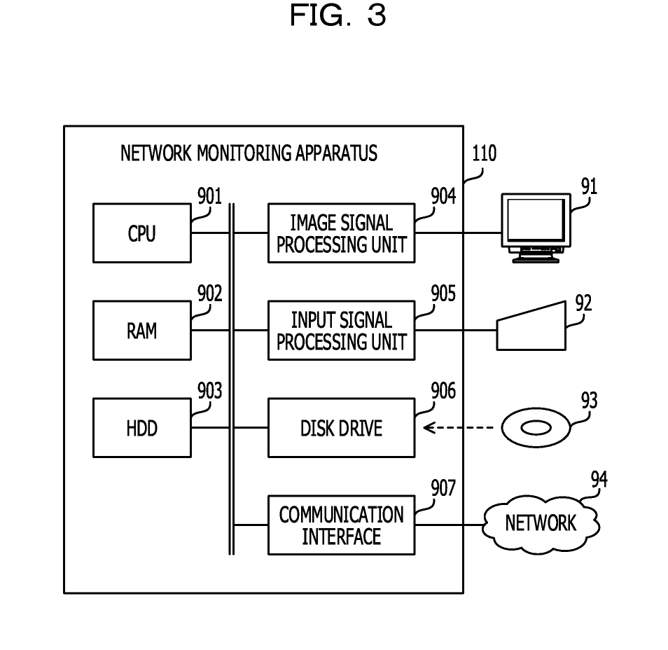

The second embodiment provides a technique to detect an illegal process such as that performed by the information processing apparatus 101 infected with an illegal program to steal confidential information or the like from the information processing apparatus 102 connected to the information processing apparatus 101 via the network 94. This method is realized by functions of the network monitoring apparatus 110. The functions of the network monitoring apparatus 110 may be realized using hardware such as that illustrated in FIG. 3.

FIG. 3 illustrates an example of a hardware configuration of a network monitoring apparatus according to the second embodiment. As illustrated in FIG. 3, the network monitoring apparatus 110 includes, for example, a CPU 901, a random access memory (RAM) 902, a hard disk drive (HDD) 903, an image signal processing unit 904, an input signal processing unit 905, a disk drive 906, and a communication interface 907.

The CPU 901 is a processor including an operation unit configured to execute a command described in a program. The CPU 901 loads at least part of a program and data stored in the HDD 903 into the RAM 902 and executes commands described in the program. The CPU 901 may include a plurality of processor cores. The network monitoring apparatus 110 may include a plurality of CPUs 901. This configuration makes it possible for the network monitoring apparatus 110 to execute a plurality of processes in parallel.

The RAM 902 is a volatile memory for temporarily storing the program executed by the CPU 901 and data used in the process. The network monitoring apparatus 110 may include a memory of a type different from that of the RAM 902. The network monitoring apparatus 110 may include a plurality of memories.

The HDD 903 is an example of a non-volatile storage apparatus that stores programs such as an operating system (OS), firmware, application software, and the like, and data used in the processes. Note that the network monitoring apparatus 110 may include a storage apparatus of a type different from that of the HDD 903, such as a flash memory, a solid state drive (SSD), or the like. The network monitoring apparatus 110 may include a plurality of storage apparatuses.

Under the control of the CPU 901, the image signal processing unit 904 outputs an image to a display device 91 connected to the network monitoring apparatus 110. The display device 91 is a display device such as a cathode ray tube (CRT) display, a liquid crystal display (LCD), a plasma display panel (PDP), an organic electro-luminescence display (OELD), or the like.

The input signal processing unit 905 acquires an input signal from an input device 92 connected to the network monitoring apparatus 110 and transfers the input signal to the CPU 901. The input device 92 may be, for example, a mouse, a keyboard, a touch panel, a touch pad, a trackball, a remote controller, a button switch, or the like.

The disk drive 906 is an apparatus configured to read out a program or data stored in a storage medium 93. The storage medium 93 may be, for example, a flexible disk (FD), a magnetic disk such as a hard disk, an optical disk such as a compact Disc (CD), a digital versatile disc (DVD), or the like, a magneto-optical (MO) disk, or the like. The disk drive 906 operates under the control of the CPU 901, for example, to store the program or the data read out from the storage medium 93 into the RAM 902 or the HDD 903.

The communication interface 907 is an interface for communicating with another computer via the network 94. The communication interface 907 may be a wire interface or a wireless interface. Part or all of the functions of the information processing apparatuses 101 and 102 and the terminal apparatus 103 may be realized using hardware similar to that of the network monitoring apparatus 110.

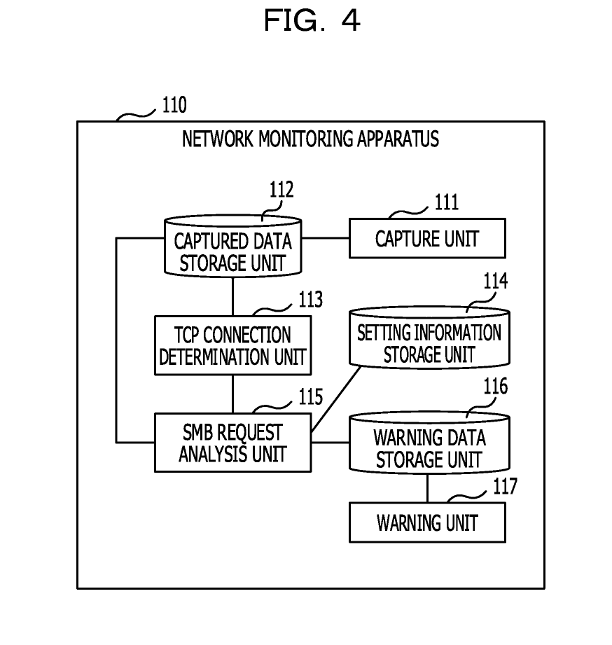

FIG. 4 is a block diagram illustrating an example of a functional configuration of the network monitoring apparatus according to the second embodiment. As illustrated in FIG. 4, the network monitoring apparatus 110 includes a capture unit 111, a captured data storage unit 112, a TCP connection determination unit 113, a setting information storage unit 114, an SMB request analysis unit 115, a warning data storage unit 116, and a warning unit 117.

Part or all of the functions of the capture unit 111, the TCP connection determination unit 113, the SMB request analysis unit 115, and the warning unit 117 may be realized by the CPU 901 by executing a program. Part or all of the functions of the capture unit 111, the TCP connection determination unit 113, the SMB request analysis unit 115, and the warning unit 117 may be realized in the form of an electronic circuit without using software. The captured data storage unit 112, the setting information storage unit 114, and the warning data storage unit 116 may be realized in storage areas allocated in the RAM 902 or the HDD 903.

The capture unit 111 captures a packet transmitted or received via the network 94. The capture unit 111 stores the captured packet together with data (time stamp) indicating a receiving time into the captured data storage unit 112. The captured data storage unit 112 serves as a storage unit for storing packets captured by the capture unit 111. The packets stored in the captured data storage unit 112 are used by the TCP connection determination unit 113 and the SMB request analysis unit 115.

The TCP connection determination unit 113 analyzes the packet stored in the captured data storage unit 112 to determine whether the packet is an ACK packet transmitted at the end of the 3-way handshaking. The 3-way handshaking is a method of establishing a TCP connection. In a case where the determination made by the TCP connection determination unit 113 indicates that the captured packet is an ACK packet in the 3-way handshaking, the TCP connection determination unit 113 requests the SMB request analysis unit 115 to analyze packets. In a case where it is determined that the packet is not an ACK packet in the 3-way handshaking, the TCP connection determination unit 113 determines whether a packet stored next in the captured data storage unit 112 is an ACK packet in the 3-way handshaking.

In responding to the packet analysis request from the TCP connection determination unit 113, the SMB request analysis unit 115 refers to setting information stored in the setting information storage unit 114. The setting information includes, for example, information indicating a level of packet analysis performed by the SMB request analysis unit 115. As described later, the higher the analysis level, the higher the attack detection probability. On the other hand, the higher the analysis level, the higher the processing load imposed on the packet analysis. The information as to the analysis level may be set beforehand, for example, by an administrator of the information processing system 100 and may be stored in the setting information storage unit 114.

The setting information storage unit 114 is the storage unit serving to store the setting information described above. The SMB request analysis unit 115 determines the analysis level by checking the analysis level information stored in the setting information storage unit 114. The SMB request analysis unit 115 checks the packets stored in the captured data storage unit 112 to determine whether there is a packet captured within the predetermined time period before the occurrence of the 3-way handshaking, thereby detecting an SMB request. The SMB request is, for example, an SMB protocol packet used by a client to request a server to perform a process.

The SMB is used to realize a file service such as file sharing. The SMB provides a file sharing service, a printer sharing service, computer name browsing, an interprocess communication (IPC), a mail slot function, and the like. The computer name browsing is a function of acquiring a list of names of computers existing on a network. The SMB also provides a function of acquiring a list of open resources available from computers existing on the network. The IPC is a mechanism that allows a plurality of processes (or between a plurality of threads) to transmit data therebetween. The mail slot function provides a mechanism (mail slot) that allows messages transmitted from a plurality of senders to be temporarily stored such that a receiving apparatus may sequentially read out messages and treat them.

Note that the SMB protocol is a file service protocol corresponding to an application layer or a presentation layer in network hierarchical layers. As for lower-order protocols below the SMB protocol, for example, a NetBIOS extended user interface (NetBEUI), a NetBIOS over TCP/IP (NBT), TCP/IP, Internetwork packet exchange/sequenced packet exchange (IPX/SPX) or the like are available. As for a protocol extended from SMB, a protocol called a common Internet file system (CIFS) is available which supports a file sharing service via a network such as the Internet.

In SMB, a peer-to-peer operation is assumed. Therefore, in SMB, it is assumed that a client transmits some request (called an SMB request) to a server, and the server responds to the request.

In a case where no SMB request is detected within a predetermined time period before the occurrence of the 3-way handshaking, the SMB request analysis unit 115 waits for receiving again a request for analyzing packets from the TCP connection determination unit 113. When a SMB request is detected, the SMB request analysis unit 115 performs a process depending on the analysis level. In the following description, it is assumed by way of example that three analysis levels (analysis level=1, 2, 3) are set.

When the analysis level is 1, the SMB request analysis unit 115 stores data of the 3-way handshaking (reverse connection) opposite in direction to the SMB request in relation to data of the SMB request in the warning data storage unit 116. A further description is given below, for example, for a case where after an SMB request is sent from the information processing apparatus 101 to the information processing apparatus 102, 3-way handshaking is performed, within a predetermined time period after the sending of the SMB request, to establish a connection from the information processing apparatus 102 to the information processing apparatus 101. In this case, the SMB request and the 3-way handshaking are opposite in direction to each other, and thus the SMB request analysis unit 115 stores data of the SMB request in relation to data of the 3-way handshaking in the warning data storage unit 116.

When the analysis level is 2, the SMB request analysis unit 115 determines whether the SMB request includes a write command. In a case where the SMB request includes no write command, the SMB request analysis unit 115 waits for receiving again a request for analyzing packets from the TCP connection determination unit 113. On the other hand, in a case where the SMB request includes a write command, the SMB request analysis unit 115 stores data of the 3-way handshaking (reverse connection) opposite in direction to the SMB request in relation to data of the SMB request into the warning data storage unit 116.

When the analysis level is 3, the SMB request analysis unit 115 determines whether the SMB request includes a write command and an executable code. In a case where the determination is negative as to whether the SMB request includes a write command and an executable code, the SMB request analysis unit 115 waits for receiving again a request for analyzing packets from the TCP connection determination unit 113. On the other hand, in a case where the SMB request includes a write command and an executable code, the SMB request analysis unit 115 checks packets stored in the captured data storage unit 112 to determine whether there is an SMB request including an execute command.

In a case where no SMB request including an execute command is found, the SMB request analysis unit 115 waits for receiving again a request for analyzing packets from the TCP connection determination unit 113. On the other hand, in a case where an SMB request including an execute command is found, the SMB request analysis unit 115 stores data of the 3-way handshaking (reverse connection) opposite in direction to the SMB request in relation to data of the SMB request into the warning data storage unit 116.

When the data of the reverse connection is stored in relation to the data of SMB request in the warning data storage unit 116, the warning unit 117 issues a warning. In this process, if a simple network management protocol (SNMP) is set, the warning unit 117 issues the warning by an SNMP trap. On the other hand, in a case where SNMP is not set, the warning unit 117 issues the warning using e-mail. The SNMP trap or the e-mail is transmitted to the terminal apparatus 103.

By configuring the network monitoring apparatus 110 so as to have the functions described above, it becomes possible to associate an SMB request and a reverse connection regarded as an attack. Furthermore, by analyzing the content of the SMB request and associating the SMB request with the reverse connection depending on a result of the analysis, it is possible to reduce the probability of wrong detection, that is, it is possible to increase the attack detection accuracy.

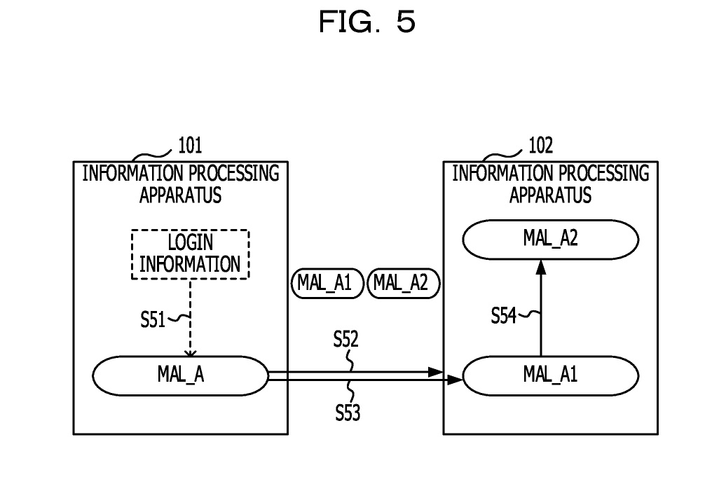

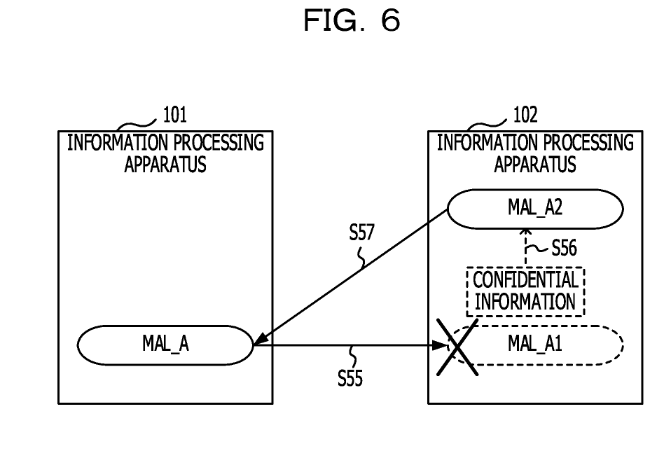

The operation of the network monitoring apparatus 110 is described in further detail below, taking as an example a case where the network monitoring apparatus 110 detects a targeted attack caused by an illegal program that intrudes into the information processing apparatus 101 and tries to steal confidential information from the information processing apparatus 102. In the following description, it is assumed by way of example that a targeted attack is performed as illustrated in FIGS. 5 and 6.

FIG. 5 is a diagram illustrating an example of a targeted attack in a first phase. In this example illustrated in FIG. 5, the information processing apparatus 101 is infected with an illegal program MAL_A. The illegal program MAL_A acquires login information possessed by the information processing apparatus 101 (S51). This login information is, for example for passing authentication of the information processing apparatus 102. After acquiring the login information, the illegal program MAL_A accesses the information processing apparatus 102 using the acquired login information, and transmits illegal programs MAL_A1 and MAL_A2 to the information processing apparatus 102 using SMB packets (S52). The illegal program MAL_A1 is executed by the information processing apparatus 102.

Furthermore, the illegal program MAL_A instructs, using a SMB packet, the illegal program MAL_A1 to starts the illegal program MAL_A2 (S53). In response to receiving the instruction, the illegal program MAL_A1 starts the illegal program MAL_A2 (S54). Thereafter, as illustrated in FIG. 6, the illegal program MAL_A deletes the illegal program MAL_A1 by using an SMB packet (S55).

FIG. 6 illustrates an example of a targeted attack in a second phase. The illegal program MAL_A1 operates as a resident process or a resident service that waits for an SMB request. When the illegal program MAL_A1 operates, the information processing apparatus 102 goes into a state in which the process or service, which does not occur in a normal state, runs for a long period, which causes the existence and the operation of the illegal program MAL_A1 to be easily detected. To avoid the above situation, the illegal program MAL_A1 is deleted shortly after the start of the illegal program MAL_A2 as illustrated in FIG. 6, to stop the illegal program MAL_A1 from being detected in a situation in which the name of the illegal program MAL_A1 is displayed for a long period in a list of processes or services.

The illegal program MAL_A2 operates not as a resident process or a resident service but as a client process. Therefore, the illegal program MAL_A2 is capable of controlling itself as to starting and stopping, which makes it possible to inhibit the process from operating continuously for a long period. Note that the illegal program MAL_A is also capable of controlling the starting and stopping of the illegal program MAL_A2. Furthermore, the illegal program MAL_A2 may be disguised as a popular application process such as a Web browser or the like to reduce the probability that the illegal program MAL_A2 is detected.

The illegal program MAL_A2 described above may acquire confidential information or the like possessed by the information processing apparatus 102 (S56). Using a port number allowed by the information processing apparatus 101 to use in communication, the illegal program MAL_A2 may connect to the illegal program MAL_A running on the information processing apparatus 101. Furthermore, the illegal program MAL_A2 may transmit the confidential information or the like acquired from the information processing apparatus 102 to the illegal program MAL_A (S57). More specifically, for example, the illegal program MAL_A2 may connect to the information processing apparatus 101 using a port number 80 and may transmit confidential information or the like according to a protocol such as HTTP.

In the case of a targeted attack such as that described above, communication used in the attack is of a type that passes a common firewall, such as an HTTP request transmitted by a Web browser, and thus there is a possibility that the attack is not detected by the firewall. When the illegal programs MAL_A1 and MAL_A2 are sent to the information processing apparatus 102, if data is concealed by using compression, coding, or other techniques, there is a possibility that the attack is not detected by pattern matching or other techniques. Furthermore, in the transmission of the illegal programs MAL_A1 and MAL_A2, no anomalous traffic occurs, and thus there is a possibility that the attack is not detected by an anomaly detection method. When a transmission of an SMB packet from the information processing apparatus 101 to the information processing apparatus 102 and an occurrence of a reverse connection are separately detected, this does not necessarily means that an attack occurs.

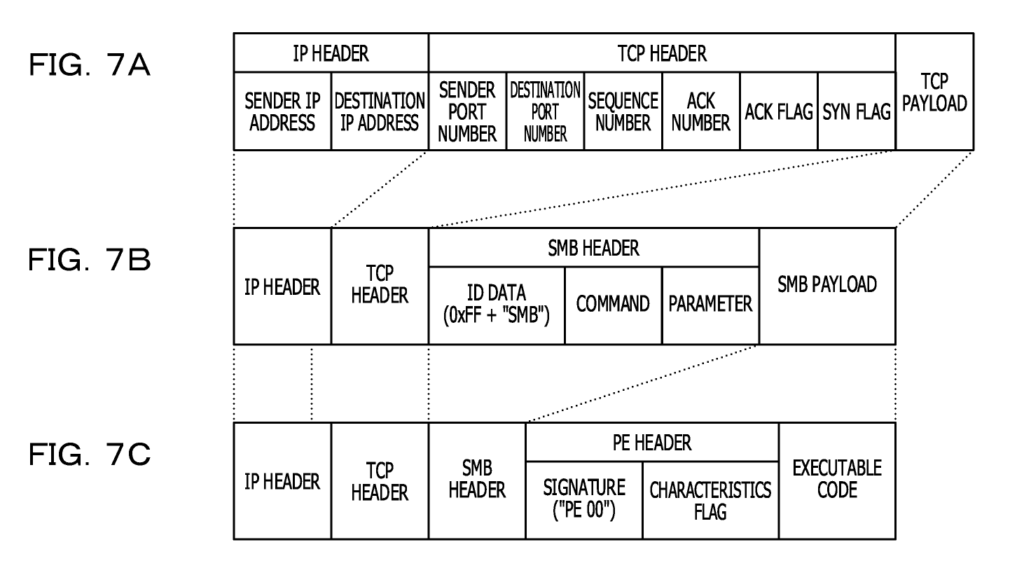

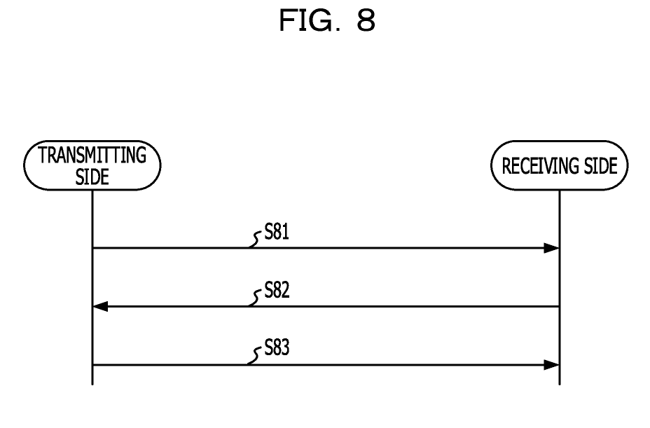

A method is described below to adapt the above-described situation. In this method, when a reverse connection that appears when a targeted attack occurs as illustrated in FIG. 5 and FIG. 6 is detected, this reverse connection related to the targeted attack is properly associated with an SMB packet. Before this method is described, a structure of an SMB packet and the mechanism of the 3-way handshaking are described with reference to FIGS. 7A to 7C and FIG. 8.

FIGS. 7A to 7C illustrate examples of structures of packets. The capture unit 111 of the network monitoring apparatus 110 captures a TCP/IP packet via the network 94. The TCP/IP packet has a structure such as that illustrated in FIG. 7A. As illustrated in FIG. 7A, the TCP/IP packet includes an IP header, a TCP header, and a TCP payload. The IP header includes an IP address of a sender and an IP address of a destination. The TCP header includes a port number of the sender, a port number of the destination, a sequence number, an ACK number, an ACK flag, and a SYN flag. The sequence number is a start byte number of data to be transmitted. The ACK number is a start byte number of data to be transmitted next in an opposite direction. The ACK flag is an acknowledgement response flag. The SYN flag is a synchronization flag.

The SMB request analysis unit 115 extracts an SMB packet from a TCP/IP packet captured by the capture unit 111. In the process, the SMB request analysis unit 115 refers to the TCP payload of the TCP/IP packet. The SMB packet has a structure such as that illustrated in FIG. 7B. That is, the TCP payload of the SMB packet includes an SMB header and an SMB payload. The SMB header includes ID data, a command, and a parameter. The ID data is located at the top of the SMB header and is 4-byte data of an identification character string indicating that the packet is an SMB protocol packet.

The command is information specifying a code number indicating a command to an apparatus on a receiving side. The command may be, for example, a folder generate command, a folder delete command, a file open command, a file generate command, a file close command, a file delete command, a file name change command, a file write command, a file readout command, a file search command, or other command to treat a file or a folder. Other available commands include a command to acquire file or system information, a command to acquire or set an attribute of a file or a directory. The parameter includes information related to an error, auxiliary information related to a command, information related to a user, or the like.

Because the SMB packet has the structure described above, the determination as to whether a captured packet is an SMB packet or not may be performed based on the destination port number (for example, 445) of the TCP header and the ID data of the SMB header. The determination as to whether the SMB packet includes the write command or not may be performed by referring to the command in the SMB header.

One of SMB packets is used to transmit an executable code. Such an SMB packet used to transmit an executable code has a structure such as that illustrated in FIG. 7C. The SMB payload of the SMB packet that transmits an executable code, as illustrated in FIG. 7C, includes a PE header and an executable code.

The PE header is a part in which a property of the executable code is written. The PE header includes a signature, a characteristic flag, or the like. The signature is predetermined 4-byte data of an identification character string located at the top of the PE header. The characteristic flag is a flag specifying an attribute value of a file. For example, in a case where IMAGE_FILE_EXECUTABLE_IMAGE (with a value of 0x0002) is specified as the characteristic flag, use of an image file such as a dynamic link library is enabled, that is, it is allowed to execute such an image file. The executable code is machine language data describing an execution procedure of a program.

The determination as to whether a captured SMB packet includes an executable code or not may be performed, for example, by referring to the signature and the characteristic flag of the PE header. By using an SMB packet including an executable code and by specifying a file write command, it is possible to write, for example, an executable code.

Next, referring to FIG. 8, the 3-way handshaking is described. FIG. 8 illustrates the 3-way handshaking. In the TCP, to ensure a high-reliability data transmission, a connection is established via a method called the 3-way handshaking. In this method, first, a packet notifying of a transmission permission request (SYN) is transmitted from an apparatus on a transmitting side to an apparatus on a receiving side (S81). That is, a packet in which the SYN flag is set to 1 to indicate the transmission permission request is transmitted from the apparatus on the transmitting side to the apparatus on the receiving side. Next, from the apparatus on the receiving side to the apparatus on the transmitting side, a packet is transmitted to notify of transmission permission and transmission permission request (SYN+ACK) (S82). That is, a packet, in which the ACK flag is set to 1 to indicate the transmission permission and the SYN flag is set to 1 to indicate the transmission permission request, is transmitted from the apparatus on the receiving side to the apparatus on the transmitting side.

When the packet notifying of the transmission permission and the transmission permission request is received by the apparatus on the transmitting side, a communication channel from the transmitting side to the receiving side is established. Next, a packet notifying of transmission permission (ACK) is transmitted from the apparatus on the transmitting side to the apparatus on the receiving side (S83). That is, a packet in which ACK flag is set to 1 to indicate the transmission permission is transmitted from the apparatus on the transmitting side to the apparatus on the receiving side. When this packet is received by the apparatus on the receiving side, a communication channel from the receiving side to the transmitting side is established. When the communication channels are established in both directions between the transmitting side and the receiving side in the above-described manner, the establishment of the connection is complete. That is, in the 3-way handshaking, the connection is established in the above-described manner.

Note that an initial value prepared by the apparatus on the transmitting side is set as the sequence number (SEQ) of the packet that is transmitted first in the 3-way handshaking from the apparatus on the transmitting side to the apparatus on the receiving side. As for the sequence number (SEQ) of the packet transmitted from the apparatus on the receiving side to the apparatus on the transmitting side, an initial value is set to a value prepared by the apparatus on the receiving side. The ACK number of this packet is set to be equal to the initial value determined at the apparatus on the transmitting side plus 1. When, in response to receiving this packet, the packet is transmitted from the apparatus on the transmitting side to the apparatus on the receiving side, the ACK number thereof is set to be equal to the initial value determined at the apparatus on the receiving side plus 1. Use of the 3-way handshaking makes it possible to realize a high-reliability data transmission.

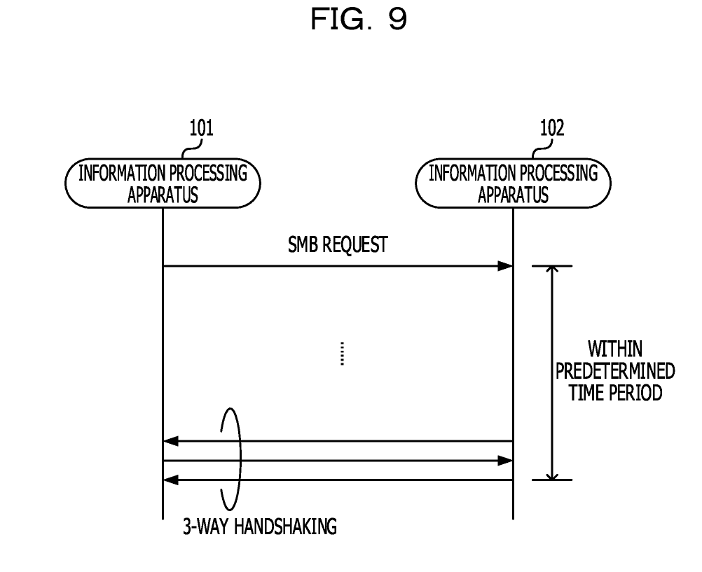

The structure of an SMB packet and the 3-way handshaking have been described above. Next, referring to FIGS. 9 to 13, a description is given below as to a method of detecting a reverse connection that occurs when a targeted attack is performed as illustrated in FIG. 5 and FIG. 6, and associating the reverse connection with an SMB packet. In the second embodiment, the method has three modes called analysis_level_1 to analysis_level_3 as described below.

First, referring to FIG. 9, a method in a mode of analysis_level_1 is described below. This method is realized by using the functions of the SMB request analysis unit 115 in the network monitoring apparatus 110. FIG. 9 illustrates a method (an example of analysis_level_1) of detecting a reverse connection according to the second embodiment.

In the case where the analysis level is analysis_level_1, if the SMB request analysis unit 115 detects an SMB request, then the SMB request analysis unit 115 monitors whether 3-way handshaking (reverse connection) in a direction opposite to the direction of the detected SMB request is performed within the predetermined time period after the detection of the SMB request. In a case where there is an SMB request detected within the predetermined time period before the reverse connection, the SMB request analysis unit 115 associates the data of the reverse connection and the data of SMB request to each other. The predetermined time period is set to a value, for example, in a range from several ten milliseconds to several hundred milliseconds. The sequence of processes including the transmission of the SMB request and the establishment of the reverse connection associated with the SMB request is regarded as part of an attack.

There is a protocol called a remote desktop protocol (RDP) based on TCP/IP. RDP is used, for example, in a communication process to transmit, to a server, information input by a user using a terminal service, or in a communication process to transmit screen information from a server to a terminal. When file sharing services by SMB and RDP are both used together, there is a possibility that after an SMB request occurs, a 3-way handshaking in RDP may occur in a direction opposite to the direction of the SMB request.

In this case, if it is determined that an attack occurs, simply based on the detection of the SMB request and the following 3-way handshaking in the opposite direction, the result is a wrong determination, that is, a normal process is improperly regarded as an attack. In this regard, in the detection method in the mode of the analysis_level_1, when an SMB request and 3-way handshaking both occur within the predetermined time period, this sequence of processes is regarded as part of an attack, which results in a reduction in probability that a normal connection process using RDP is improperly regarded as an attack.

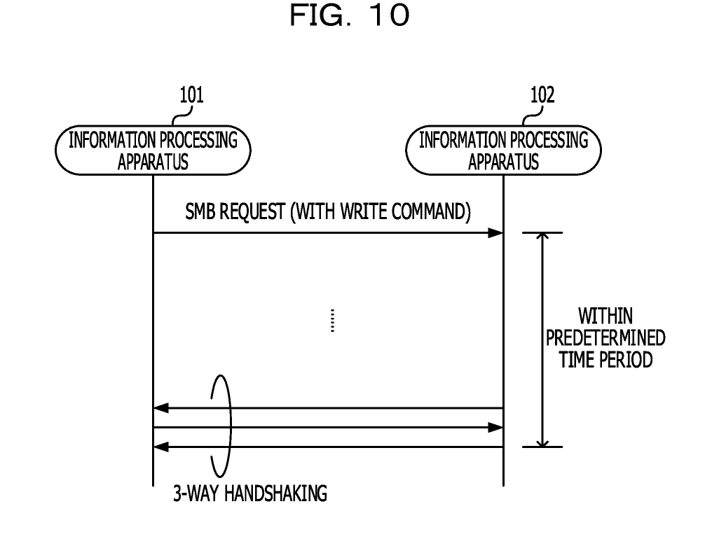

Next, referring to FIG. 10, a method in the mode of the analysis_level_2 is described below. This method is realized by the functions of the SMB request analysis unit 115 in the network monitoring apparatus 110. FIG. 10 is a diagram illustrating a method (an example of analysis_level_2) of detecting a reverse connection according to the second embodiment.

In the analysis_level_2, if the SMB request analysis unit 115 detects an SMB request, then the SMB request analysis unit 115 monitors whether 3-way handshaking (reverse connection) in a direction opposite to the direction of the detected SMB request is performed within the predetermined time period after the detection of the SMB request. Furthermore, the SMB request analysis unit 115 determines whether the detected SMB request includes a write command. In a case where there is an SMB request detected in the predetermined time period before the reverse connection and this SMB request includes a write command, the SMB request analysis unit 115 associates the data of the reverse connection and the data of SMB request to each other.

That is, when a corresponding SMB payload includes file data to be written and a request (SMB request including a write command) for storing the file data into the information processing apparatus 102 is detected within the predetermined time period, the associating process described above is performed.

The sequence of processes including the transmission of the SMB request and the establishment of the reverse connection associated with the SMB request is regarded as part of an attack. As in the analysis_level_1, by limiting the time period within which a reverse connection is detected after the detection of an SMB request, it is possible to reduce the probability that a normal process such as an RDP connection process is improperly regarded as an attack. Furthermore, by performing the determination as to whether the SMB request includes a write command, it becomes possible to inhibit an SMB request, which is not an SMB request for writing data in a file, from being improperly associated with a reverse connection, which results in a further reduction in probability that a normal process is improperly regarded as an attack.

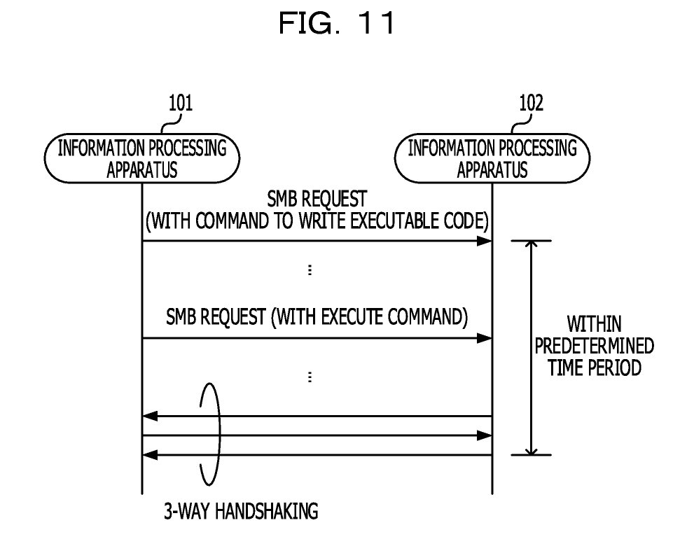

Next, referring to FIG. 11, a method in the mode of the analysis_level_3 is described below. This method is realized by the functions of the SMB request analysis unit 115 in the network monitoring apparatus 110. FIG. 11 is a diagram illustrating a method (an example of analysis_level_3) of detecting a reverse connection according to the second embodiment.

In the analysis_level_3, the SMB request analysis unit 115 detects an SMB request, then the SMB request analysis unit 115 monitors whether 3-way handshaking (reverse connection) in a direction opposite to the direction of the detected SMB request is performed within a predetermined time period after the detection of the SMB request. Furthermore, the SMB request analysis unit 115 determines whether the detected SMB request includes a command to write an executable code. The determination as to whether the detected SMB request includes a command to write an executable code may be performed, for example, by checking whether IMAGE_FILE_EXECUTABLE_IMAGE (with a value of 0x0002) is specified as the characteristic flag in the PE header of the SMB request.

Furthermore, the SMB request analysis unit 115 determines whether an SMB request including an execute command is detected. Here the execute command refers to a combination of a write command and a parameter indicating an instruction to execute the executable code transmitted in a previous SMB request. In a case where an SMB request including a command to write an executable code is detected within a predetermined time period before the detection of a reverse connection, and furthermore an SMB request including an execute command is detected between the command to write an executable code and the reverse connection, the SMB request analysis unit 115 associates the reverse connection and the SMB request to each other. The sequence of processes including the transmission of the SMB request and the establishment of the reverse connection associated with the SMB request is regarded as part of an attack.

As described above, by limiting the time period within which a reverse connection is detected after the detection of an SMB request, and furthermore by performing the determination as to whether the SMB request includes a write command, it is possible, as in the analysis_level_2, to reduce the probability that a normal process is improperly regarded as an attack. Furthermore, by detecting a command to write an executable code and an execute command by analyzing SMB requests, it becomes possible to further reduce the probability that a normal process is improperly regarded as an attack.

As described above, the analysis_level_2 provides a lower probability of wrong detection than the analysis_level_1 provides. Furthermore, the analysis_level_3 provides a further lower probability of wrong detection than the analysis_level_2 provides. However, in the analysis_level_2, the process of determining whether an SMB request includes a write command causes an increase in processing load compared with the analysis_level_1. In the analysis_level_3, the process of detecting a command to write an executable code and an execute command causes an increase in processing load compared with the analysis_level_2. Therefore, in setting the analysis level, there is tradeoff between the detection accuracy and the processing load.

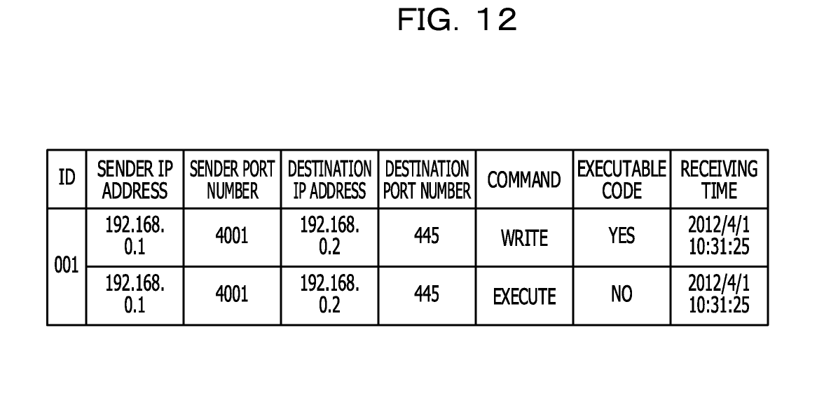

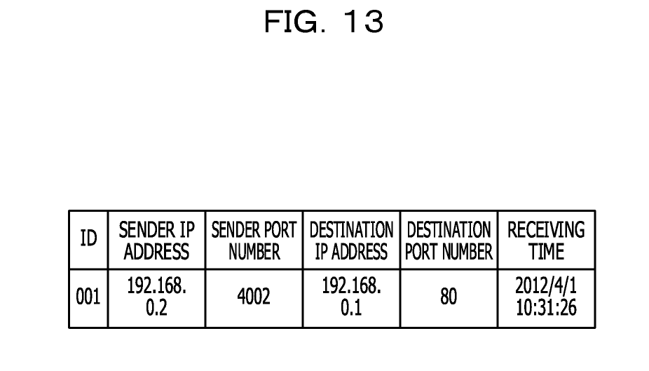

Referring to FIG. 12 and FIG. 13, a further description is given below as to the method of detecting a reverse connection and a method of determining whether an SMB request is to be associated with the reverse connection. FIG. 12 illustrates an example of an SMB request table. Warning data is generated by the SMB request analysis unit 115 and stored in the warning data storage unit 116. The SMB request table stores such warning data related to an SMB request. FIG. 12 illustrates a data structure of such warning data related to an SMB request.

As illustrated in FIG. 12, the SMB request table stores information related to an ID, a sender IP address, a sender port number, a destination IP address, a destination port number, a command, an executable code, and a receiving time. The receiving time indicates a time at which an SMB request was received. The ID is identification information identifying a relation with a corresponding reverse connection.

In the example illustrated in FIG. 11, an SMB request including a command to write an executable code and an SMB request including an execute command are detected. In this case, the SMB request analysis unit 115 describes “WRITE” in a field of command of the SMB request table for the SMB request including the command to write an executable code, and describes “YES” in a field of executable code. Furthermore, the SMB request analysis unit 115 describes information related to the receiving time and other information in the SMB request table for this SMB request. Similarly, for the SMB request including the execute command, the SMB request analysis unit 115 describes “EXECUTE” in the field of command, and “NO” in the field of executable code in the SMB request table.

When a reverse connection is detected, the SMB request analysis unit 115 in the network monitoring apparatus 110 describes information related to the reverse connection in a reverse connection table as illustrated in FIG. 13.

FIG. 13 illustrates an example of a reverse connection table. As illustrated in FIG. 13, the reverse connection table stores information related to an ID, a sender IP address, a sender port number, a destination IP address, a destination port number, and a receiving time. The ID is identification information identifying a relation with a corresponding SMB request. The sender IP address and the sender port number respectively indicate a sender IP address and a sender port number of a SYN packet transmitted first in the 3-way handshaking or of an ACK packet transmitted last in the 3-way handshaking. The destination IP address and the destination port number respectively indicate a destination IP address and a destination port number of a SYN packet transmitted first in the 3-way handshaking or of an ACK packet transmitted last in the 3-way handshaking. The receiving time indicates, for example, a time at which the ACK packet was received last in the 3-way handshaking of the reverse connection.

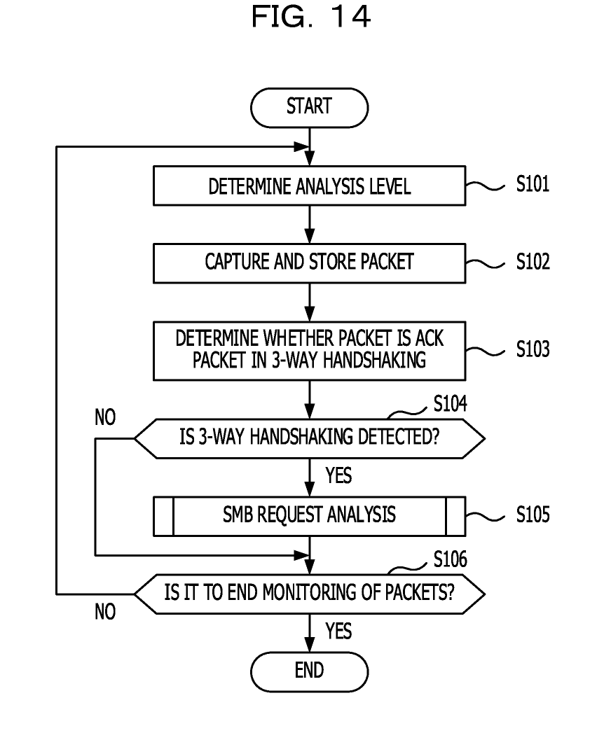

The description has been given above as to the method of detecting a reverse connection that occurs in a targeted attack and the method of associating this reverse connection with an SMB packet. Next, referring to FIGS. 14 to 16, a flow of a monitoring process according to the second embodiment is described below. The monitoring process described below is performed by the network monitoring apparatus 110. FIG. 14 is a first flowchart illustrating the flow of the monitoring process according to the second embodiment.

In S101, the SMB request analysis unit 115 refers to setting information stored in the setting information storage unit 114. The setting information includes, for example, analysis level information indicating a level of packet analysis executed by the SMB request analysis unit 115. The analysis level information is, for example, set beforehand by an administrator or the like of the information processing system 100 and stored in the setting information storage unit 114. The SMB request analysis unit 115 determines the analysis level by referring to the information as to the analysis level stored in the setting information storage unit 114. Alternatively, the SMB request analysis unit 115 may prompt a user to input analysis level information.

In S102, the capture unit 111 captures a packet transmitted or received via the network 94. The capture unit 111 stores the captured packet, together with data indicating the time (receiving time) at which the packet was captured, in the captured data storage unit 112.

In S103, the TCP connection determination unit 113 analyzes the packet stored in the captured data storage unit 112 to determine whether the packet is a last one (ACK packet) in the 3-way handshaking. The determination as to whether the captured packet is the ACK packet in the 3-way handshaking may be performed by determining whether a SYN packet, a SYN+ACK packet, and an ACK packet have been detected sequentially in this order as illustrated in FIG. 8. The correspondence among these three packets may be known, for example, by referring to a sender IP address, a destination IP address, a sender port number, and a destination port number of each packet.

In S104, if the TCP connection determination unit 113 determines in S103 that the packet is an ACK packet in the 3-way handshaking (that is, a TCP connection is established via the 3-way handshaking), then the process proceeds to S105. On the other hand, in a case where the TCP connection determination unit 113 determines in S103 that the packet is not an ACK packet in the 3-way handshaking, the process proceeds to S106.

In S105, the SMB request analysis unit 115 checks the packets stored in the captured data storage unit 112 to determine whether there is a packet captured within a predetermined time period before the execution of the 3-way handshaking to find an SMB request.

More specifically, the SMB request analysis unit 115 searches for an SMB request with the sender IP address and the destination IP address that are opposite in direction to the sender IP address and the destination IP address of the SYN packet or the ACK packet in the 3-way handshaking. In this process, the SMB request analysis unit 115 searches for, for example, an SMB request captured within the predetermined time period before the reception of the last packet (ACK packet) in the 3-way handshaking.

In a case where an SMB request is detected, the SMB request analysis unit 115 analyzes the SMB request.

In S106, the network monitoring apparatus 110 determines whether the packet monitoring is to be ended or not. In a case where a monitoring end condition is satisfied, and more specifically, for example, when a command to end the monitoring is issued by a user, or when a predetermined monitoring time has elapsed, the network monitoring apparatus 110 ends the packet monitoring process. In a case where it is determined that the packet monitoring is to be ended, the sequence of processes illustrated in FIG. 14 is ended. On the other hand, in a case where it is determined that the packet monitoring is not to be ended, the process proceeds to S101.

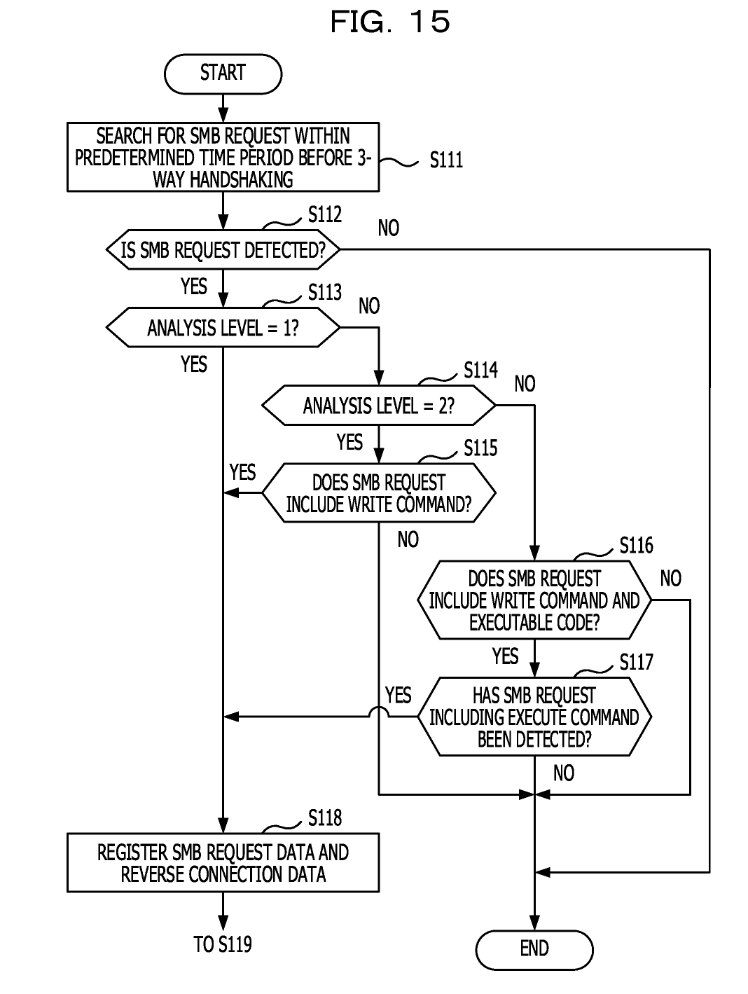

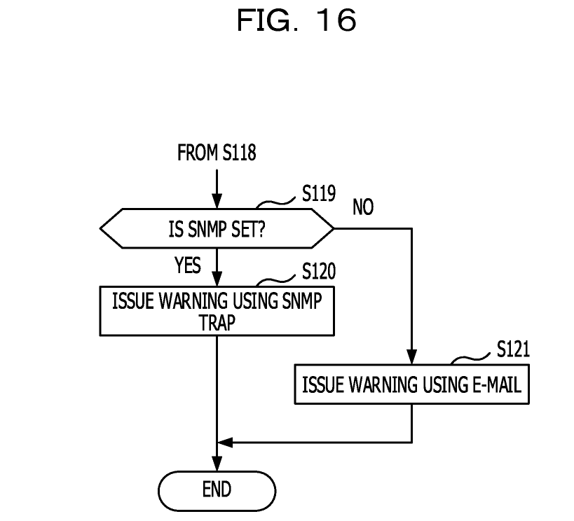

Referring to FIG. 15 and FIG. 16, the process in S105 is further described. FIG. 15 is a second flowchart illustrating the flow of the monitoring process according to the second embodiment.

In S111, the SMB request analysis unit 115 checks the packets stored in the captured data storage unit 112 to determine whether there is a packet captured within the predetermined time period before the execution of the 3-way handshaking (for example, within the predetermined time period before the reception of the last packet (ACK packet) in the 3-way handshaking), to find an SMB request. More specifically, in the finding of the SMB request, the SMB request analysis unit 115 searches for an SMB request with the sender IP address and the destination IP address that are opposite in direction to the sender IP address and the destination IP address of the SYN packet or the ACK packet in the 3-way handshaking.

In S112, if no SMB request is detected, the SMB request analysis unit 115 ends the sequence of processes in S105. On the other hand, in a case where an SMB request is detected, the SMB request analysis unit 115 performs a process depending on the analysis level.

In S113, if the analysis level is 1, the process proceeds to S118. When the analysis level is not 1, the process proceeds to S114.

In S114, if the analysis level is 2, the process proceeds to S115. If the analysis level is not 2, the process proceeds to S116.

In S115, the SMB request analysis unit 115 determines whether the SMB request includes a write command. The determination as to whether the SMB request includes a write command may be performed by referring to a command described in the SMB header. In a case where the SMB request includes no write command, the sequence of processes in S105 is ended. On the other hand, in a case where the SMB request includes a write command, the process proceeds to S118.

In S116, the SMB request analysis unit 115 determines whether the SMB request includes a write command and an executable code. The determination as to whether the SMB request includes an executable code may be performed, for example, based on the signature and the characteristic flag in the PE header of the SMB request. In a case where the SMB request includes no write command or no executable code, the sequence of processes in S105 is ended. On the other hand, in a case where the SMB request includes a write command and an executable code, the process proceeds to S117.

In S117, the SMB request analysis unit 115 searches for a packet captured after the SMB request including the write command and the executable code and within a predetermined time period before the occurrence of the 3-way handshaking, to determine whether an SMB request including an execute command has been detected. In a case where no SMB request including an execute command is detected, the sequence of processes in S105 is ended. On the other hand, in a case where an SMB request including an execute command is detected, the process proceeds to S118.

In S118, the SMB request analysis unit 115 associates the data of the 3-way handshaking (reverse connection) opposite in direction to the SMB request to the data of the SMB request and generates warning data. For example, the SMB request analysis unit 115 generates an SMB request table such as that illustrated in FIG. 12 and a reverse connection table such as that illustrated in FIG. 13, and the SMB request analysis unit 115 stores the result in the warning data storage unit 116. After S118 is complete, the process proceeds to S119 illustrated in FIG. 16.

FIG. 16 is a third flowchart illustrating the flow of the monitoring process according to the second embodiment.

In S119, the warning unit 117 determines whether SNMP is set in the network monitoring apparatus 110. In a case where SNMP is set, the process proceeds to S120. On the other hand, in a case where SNMP is not set, the process proceeds to S121.

In S120, the warning unit 117 transmits an SNMP trap to the terminal apparatus 103 used by the administrator. For example, the warning unit 117 transmits, as warning data, the SMB request table and the reverse connection table stored in the warning data storage unit 116. When the process in S120 is complete, the sequence of processes in S105 is ended.

In S121, the warning unit 117 transmits an e-mail to the terminal apparatus 103 used by the administrator via a mail server (not illustrated). For example, the warning unit 117 transmits, as warning data, the SMB request table and the reverse connection table stored in the warning data storage unit 116. When the process in S121 is complete, the sequence of processes in S105 is ended.

The flow of the monitoring process according to the second embodiment has been described above. As described above, in the mode of the analysis_level_1 according to the second embodiment, by limiting the time period within which a reverse connection is detected after the detection of an SMB request, it is possible to reduce the probability that a normal process such as a RDP connection process is improperly regarded as an attack. In the mode of the analysis_level_2, by performing the determination as to whether the SMB request includes a write command, it is possible to further reduce the probability that a normal process is improperly regarded as an attack. In the mode of the analysis_level_3, by analyzing an SMB request to detect a command to write an executable code and an execute command, it becomes possible to further reduce the probability that a normal process is improperly regarded as an attack.

The analysis_level_2 provides a lower probability of wrong detection than the analysis_level_1 provides. Furthermore, the analysis_level_3 provides a further lower probability of wrong detection than the analysis_level_2 provides. However, in the analysis_level_2, the process of determining whether an SMB request includes a write command causes an increase in processing load compared with the analysis_level_1. In the analysis_level_3, the process of detecting a command to write an executable code and an execute command causes an increase in processing load compared with the analysis_level_2.

In view of the above, when the detection accuracy is important, it is preferable to employ the analysis_level_3. When a low processing load is important, it is preferable to employ the analysis_level_1. To achieve a good balance between the detection accuracy and the processing load, it is preferable to employ the analysis_level_2. That is, in setting the analysis level, there is tradeoff between the detection accuracy and the processing load.

The application of the technique described above makes it possible to, for example, detect a reverse connection established by malware having a personal fire wall (PFW) bypass function. It also becomes possible to detect an attack using a normal packet that does not violate a widely used protocol such as HTTP. Furthermore, it also becomes possible to detect an activity of malware that is difficult to detect by a method, such as pattern matching, using a signature included in a packet.

In the technique disclosed above, an attack is detected based on a result of a detection of a behavior related to a transmission and execution of malware in combination with a result of a detection of a behavior related to a transmission of confidential information or the like, and thus it is possible to achieve high attack detection accuracy.

In the above description, the detection method has been described taking as an example a targeted attack involving transmission and execution of an illegal program using an SMB packet. However, the application of the second embodiment is not limited to SMB.

That is, packets according to other protocols include information as to a sender address and a destination address, and thus it is possible to detect a reverse connection by judging a communication direction using the technique according to the second embodiment. The receiving time may be recorded by the network monitoring apparatus 110, which makes it possible to search for a packet received within a predetermined time period before the occurrence of the reverse connection. Furthermore, by using information indicating whether or not it is allowed to execute an executable code included in a payload, it is possible to associate a packet and a reverse connection to each other with high accuracy. Such and other similar modifications fall into the scope of the second embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for detecting illegal connection, the method comprising:
acquiring, by a network monitoring apparatus, a first packet transmitted from a first information processing apparatus to a second information processing apparatus;
acquiring a second packet transmitted from the second information processing apparatus to the first information processing apparatus, the second packet being transmitted within a predetermined time period since the transmission of the first packet;
determining whether
the first packet is a packet according to a protocol used for transmitting a file and
the second packet is related to a connection established from the second information processing apparatus to the first information processing apparatus; and
outputting result information depending on a result of the determination.

2. The method according to claim 1, wherein
the first packet includes a file write command to write a file.

3. The method according to claim 1, wherein
the first packet includes an executable code.

4. The method according to claim 3, further comprising:
acquiring a third packet transmitted from the first information processing apparatus to the second information processing apparatus after the first packet and before the second packet; and
determining whether the third packet includes an execute command to cause the second information processing apparatus to execute the executable code.

5. The method according to claim 1, wherein
the result information includes information associating the first packet with the connection.

6. A network monitoring apparatus comprising:
a receiving unit to acquire a first packet and a second packet, the first packet being transmitted from a first information processing apparatus to a second information processing apparatus, the second packet being transmitted from the second information processing apparatus to the first information processing apparatus within a predetermined time period since the transmission of the first packet; and
a processor or a hardware circuit to
determine whether
the first packet is a packet according to a protocol used for transmitting a file and
the second packet is related to a connection established from the second information processing apparatus to the first information processing apparatus, and
output result information depending on a result of the determination.

7. A computer-readable recording medium storing a program that causes a computer to execute a procedure, the procedure comprising:
acquiring a first packet transmitted from a first information processing apparatus to a second information processing apparatus;
acquiring a second packet transmitted from the second information processing apparatus to the first information processing apparatus, the second packet being transmitted within a predetermined time period since the transmission of the first packet;
determining whether
the first packet is a packet according to a protocol used for transmitting a file and
the second packet is related to a connection established from the second information processing apparatus to the first information processing apparatus; and
outputting result information depending on a result of the determination.
